(19) United States
(12) Patent Application Publication
(10) Pub. No.: US 2013/0212040 A1
(43) Pub. Date: Aug. 15, 2013

(54) METHOD OF RESTRUCTURING INDEX SECURITIES FUNDS BY REVENUE WEIGHTING

(71) Applicant: Vincent T. Lowry, Medford, NJ (US)

(72) Inventor: Vincent T. Lowry, Medford, NJ (US)

(21) Appl. No.: 13/585,310

(22) Filed: Aug. 14, 2012

Related U.S. Application Data
(63) Continuation-in-part of application No. 11/709,446, filed on Feb. 22, 2007, now abandoned.
(60) Provisional application No. 60/775,960, filed on Feb. 23, 2006.

(51) Int. Cl. G06Q 40/06

(52) U.S. Cl. CPC G06Q 40/06
USPC 705/36 R

(57) ABSTRACT

A methodology for weighting individual securities maintained within a known index investment fund, and reconstructing the proportionate holdings of each of the stocks within the index investment fund as function of the calculated weighting. The inventive method and system considers each of the constituent securities in a known index fund and weights each said constituent security based upon a revenue weighting analysis. The known index fund is then reconstructed using the same constituent securities, and using the revenue weighting analysis to reproportion the holdings of each of the constituent securities as a function of the total revenue for the securities within the index fund. In a preferred embodiment, the weighting coefficients are recalculated on a pre-selected periodic basis, and the fund is then reconstructed based upon those recalculated weighting coefficients.

### CROSS REFERENCE TO RELATED APPLICATIONS

This application claims the benefit of priority to U.S. Provisional Patent Application No. 60/775,960, filed on Feb. 23, 2006, and is a continuation-in-part of U.S. patent application Ser. No. 11/709,446, filed on Feb. 22, 2007. The contents of both prior applications are incorporated in this application by reference.

### TECHNICAL FIELD

The present invention relates to methods and systems used for creating securities funds that provide a sound and consistent vehicle for investing within the stock market. More particularly, the disclosed invention relates to a methodology for reconstructing the amount or proportion of each constituent stock held in a known index fund where the reconstruction is based upon a function of revenue-weighting for each constituent stock.

### BACKGROUND OF THE INVENTION

The total value of money invested in the various stock and commodities markets, and in particular the moneys invested in mutual funds has grown substantially over the past several decades. Indeed, the increase of retirement accounts and facilities, including value held in 401(k) vehicles, and investing in mutual funds seems to achieve new and higher levels each year. For many investors, mutual funds have become a standard vehicle for investing one's retirement moneys and savings to be used for children's education. One reason for such growth is simply that mutual funds offer a relatively inexpensive means of managed investment intelligence. That is, the fund manager provides a fund-wide level of management to all investors in that fund, without the need for the individual investor to retain a specific investment manager or expert.

A second reason for such rapid growth in mutual fund investing is the wide array and selection of mutual fund investment styles. By way of example, the philosophies and structure of the many investment funds provide, on the one hand, the traditional and well-known funds, such as the Standard's & Poor 500®, the Russell 1000, and variations of those funds, such as the S&P MidCap 400™, and the S&P SmallCap 600™, as well as, on the other hand, non-traditional funds that focus on particular types of stocks, technologies, or areas. For example, there are children's funds that are comprised of companies well-known to, and that cater to the youth market.

While there are many different styles of mutual funds to invest in, most all of the known index funds weight the constituent securities based upon consideration of the market capitalization of the underlying companies. Examples of such market capitalization weighted index funds include the above noted S&P 500®, Russell 1000, and the FTSE 100. What is not currently known is a structuring or reconstructing of any of these known index funds according to some other measure or metric. The inventors have researched and determined that one such fund/company measure that appears to show improved returns as compared to the traditional market capitalization, is through the use of revenue weighting of the constituent stock companies in proportion to the total revenue of all of the companies that make up the selected, known mutual fund.

Within the art of investment systems and processes, there are several methods and systems disclosing various investment strategies that have been patented and disclosed, or are pending patent applications, and also disclosed. None of these methods and systems however appear to teach a method for reconstructing a known index fund using revenue weighting or reconstructing the index as a function of revenue weighting.

One example, U.S. Pat. No. 6,754,639, issued to Philip Ginsberg on Jun. 22, 2004, for a Fixed Income Portfolio Index Processor (the “'639 patent”), discloses a data processing system and method for determining an index value of a fixed-income instrument using market data, which data includes current market price, yield to maturity value, and duration. While the '639 patent does relate to the determination of a performance measure for one or more fixed-income instruments, the patent does not disclose any method or process to build or reconstruct a known index fund using the identified constituent index securities. Moreover, there is no suggestion of using any type of weighting or more specifically, revenue weighting to build or reconstruct an index fund.

Another example of a patented investment method is U.S. Pat. No. 5,857,176, also issued to Philip Ginsberg on Jan. 5, 1999, for a Fixed Income Portfolio Index Processor (the “'176 patent”). The '176 patent teaches, similar to the '639 patent, a data processing system and method for determining an index value for a fixed-income instrument using a variety of real-time market data. The market data includes market price, yield to maturity value, and duration. Like the '639 patent, this second Ginsberg patent also relates to a determination of a performance measure for fixed-income instruments. However, the '176 patent does not disclose any method or process for building or reconstructing an index fund using known constituent index securities.

U.S. Pat. No. 5,819,238, issued to Erhard Fernholz on Oct. 6, 1998, for a Apparatus and Accompanying Methods for Automatically Modifying a Financial Portfolio Through Dynamic Re-Weighting Based on a Non-Constant Function of Current Capitalization Weights (the “'238 patent”), provides a detailed description for an apparatus and various methods for automatically modifying a portfolio, such as an index fund that tracks a given capitalization weighted index, by re-weighting of the portfolio securities in proportion to a non-constant function of current capitalization weights. The Fernholz method strives to automatically trade individual stocks to have the actual stock weighting be re-balanced in line with a target weighting for that stock based upon a function of current capitalization weights. Fernholz specifically explains that “by dynamically re-weighting the position of each security in the portfolio in a manner proportional to a non-constant function of current capitalization weights of the securities in the index, then, for appropriately selected functions, the resultant return generated by a portfolio will consistently and reliably outperform that of the index itself.” Fernholz, col. 15, lines 54 through 60 (emphasis added). As such, while Fernholz does describe a system for “re-weighting” or reconstructing an index fund, there does not appear to be any suggestion in Fernholz to use any non-capitalization type of weighting algorithm, such as revenue weighting.

In addition to the above noted issued patents, U.S. Patent Application Publication No. US 2005/0171884, by Robert Arnott, published on Aug. 4, 2005, discloses a Non-Capitalization Weighted Indexing System, Method and Computer Program Product (“Arnott”). The Arnott application broadly teaches a method for building indexes using metrics other than market capitalization, price weighting or equal weighting. Arnott globally lists possible metrics to evaluate in building the index, including, without limitation, book value, sales, revenue, earnings, earnings per share, income, dividends, dividends per share, tax, as well as other non-financial metrics. In one disclosed embodiment, the Arnott application provides a method that includes the steps of (i) gathering data about a plurality of assets, (ii) selecting a plurality of assets to create an index; (iii) weighting each of the assets based upon an objective measure of scale, where the weighting is accomplished on at least one of the plurality of assets, and the weighting is based upon metrics other than market capitalization, equal weighting or share price weighting.

Arnott is accordingly limited to creating a new index (“a method . . . for passive investing that is based on indexes which are built with metrics other than market capitalization weighting”). The only suggestion in the Arnott application for rebuilding or reconstructing an index fund is after the index is built, then “the index can be rebalanced when a pre-determined threshold is reached.” There does not appear to be any disclosure or suggestion in Arnott to use the noted method of non-capitalization metrics to reconstruct or rebuild a known established index fund with known, predetermined individual securities.

Finally, U.S. Patent Application Publication No. US 2005/0216384, by Daniel Partlow, Kam Haq, Maria Mejevitch, and Sean O'Malley, published on Sep. 29, 2005, describes a System, Method, and Computer Program for Creating and Valuing Financial Instruments Linked to Real Estate Indices (“Partlow et al.”). Partlow et al. narrowly discloses a method and system for creating and valuing financial instruments directly relating to published real estate indices. More specifically, Partlow et al. seeks to claim a method for “creating and valuing financial instruments based upon real estate indices which compile real estate price information for localities, cities, regions, states, nations, or multinational/international areas.” Partlow et al., at 27, claim 1. Accordingly, Partlow et al. specifically describe financial instrument methods as a function of real estate information. There is no suggestion of using any revenue weighting for an underlying company.

Accordingly, there does not appear to be any known prior art methods, systems, patents, or published patent applications that disclose or address the potential advantages of reconstructing a known index fund using revenue weighting instead of market capitalization. Such a method and system would be highly desirable for investors, investment funds and the various equity market participants, as another sound vehicle for investing funds within the financial markets. Such an improved method and system has not been seen or achieved in the relevant art.

### SUMMARY OF THE INVENTION

The above noted problems, which are inadequately or incompletely resolved by the prior art are completely addressed and resolved by the present invention.

A preferred aspect of the invention is a method for re-constructing a known index fund, the method comprising the steps of selecting a known index fund, the index fund having a plurality of known constituent securities associated with particular companies; calculating a weighting coefficient for each of the plurality of known constituent securities, where each of the weighting coefficients is determined as the ratio of the revenue of the underlying company for each of the constituent securities to the total revenue for all of the index fund companies; applying each calculated weighting coefficient to each of the respective plurality of constituent securities to calculate the proportion of each of the respective plurality of constituent securities to be held in the reconstructed fund; and reconstructing the known index fund based upon the proportion of each of the plurality of constituent securities determined by applying the calculated weighting coefficients.

Another preferred embodiment of the claimed invention, is a method for re-constructing a known index fund, the method comprising the steps of selecting a known index fund, the index fund having a plurality of known constituent securities associated with particular companies; calculating a weighting coefficient for each of the plurality of known constituent securities, where each of the weighting coefficients is determined as the ratio of the revenue of the underlying company for each of the constituent securities to the total revenue for all of the index fund companies; applying each calculated weighting coefficient to each of the respective plurality of constituent securities to calculate the proportion of each of the respective plurality of constituent securities to be held in the reconstructed fund; reconstructing the known index fund based upon the proportion of each of the plurality of constituent securities determined by applying the calculated weighting coefficients; recalculating on a set periodic basis, the weighting coefficients as calculated for each of the plurality of constituent securities within the known index fund; and reconstructing the known index fund based upon the proportion of each of the plurality of constituent securities determined by applying the recalculated weighting coefficients.

Another embodiment of the present invention is a method for re-constituting the number of shares held for each of a plurality of constituent securities within a known index fund, the method comprising the steps of selecting a known index fund, said index fund having at least two constituent securities associated with known companies; calculating a weighting coefficient for each of the constituent securities within the known index fund, wherein the weighting coefficient is based upon the revenue of the underlying company for each of the constituent securities as a percentage of the total revenue for the index fund companies; applying each calculated weighting coefficient to each of the respective at least two constituent securities; and reconstructing the known index fund using each of the at least two constituent securities as proportioned according to the applied weighting coefficients.

Still another embodiment of the present invention is a method for re-constituting the number of shares held for each of a plurality of constituent securities within a known index fund, the method comprising the steps of selecting a known index fund, said index fund having at least two constituent securities associated with known companies; calculating a weighting coefficient for each of the constituent securities within the known index fund, wherein the weighting coefficient is based upon the revenue of the underlying company for each of the constituent securities as a percentage of the total revenue for the index fund companies; applying each calculated weighting coefficient to each of the respective at least two constituent securities; reconstructing the known index fund using each of the at least two constituent securities as proportioned according to the applied weighting coefficients; recalculating on a set periodic basis, the weighting coefficients as calculated for each of the at least two constituent securities within the known index fund; and reconstructing the known index fund based upon the proportion of each of the at least two constituent securities determined by applying the recalculated weighting coefficients.

In alternate aspects of the present invention, the method for re-constructing a known index fund, and calculating of the weighting coefficients may be undertaken on a periodic basis, including every calendar year end, every month end, or at the end of each trading day.

The invention will be best understood by reading the following detailed description of the several disclosed embodiments in conjunction with the attached drawings that briefly described below.

### BRIEF DESCRIPTION OF THE DRAWINGS

For the purpose of illustrating the invention, the attached drawings show several embodiments and aspects of several embodiments that are presently preferred. However, it should be understood that the invention is not limited to the precise steps arrangement, and method or system flow shown in the accompanying drawings.

FIG. 1: is a flowchart illustrating the inventive method of reconstructing a known index fund based upon market capitalization into a new fund structure based upon revenue weighting;

FIG. 2: is a flowchart of an embodiment of the inventive method for reconstructing a known index fund using annual revenue weighting; and

FIG. 3: is a flowchart of a second embodiment of the inventive method for reconstructing a known index fund using intermediate revenue weighting.

### DETAILED DESCRIPTION OF THE INVENTION

The vast majority of index security funds are weighted based upon a calculation of the market capitalization of each of the underlying companies represented within the fund. Indeed, all of the major known index funds, including the S&P 500®, the Russell 1000, and the FTSE 100 (the latter in the United Kingdom), are examples of funds that use market capitalization to determine the weighting or proportion of individual securities held within the index fund.

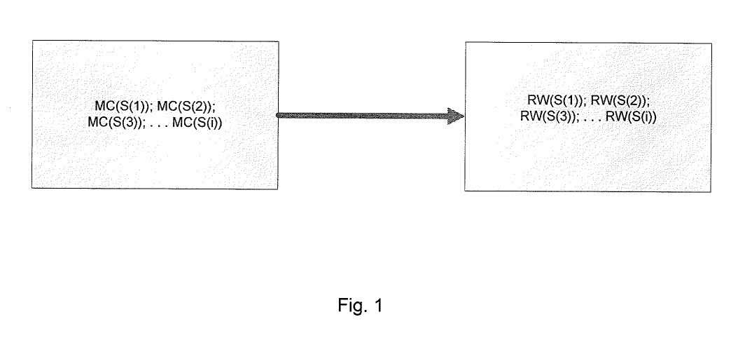

An alternative to weighting based upon market capitalization is weighting the proportion of constituent securities as a function of the revenues for each of the companies associated with each of the constituent securities. As illustrated in FIG. 1, the inventive method discloses the steps for re-calculating the weightings for each individual financial security maintained within a known index investment fund (which uses market capitalized (MC) weighting for the constituent securities) based upon a revenue weighting (RW) analysis. The weightings may be used to determine or re-calculate appropriate proportions for each of the financial securities within the known index investment fund. This re-construction of a known index fund provides an alternative fund structure from the original proportions and the market capitalized structure of the known fund.

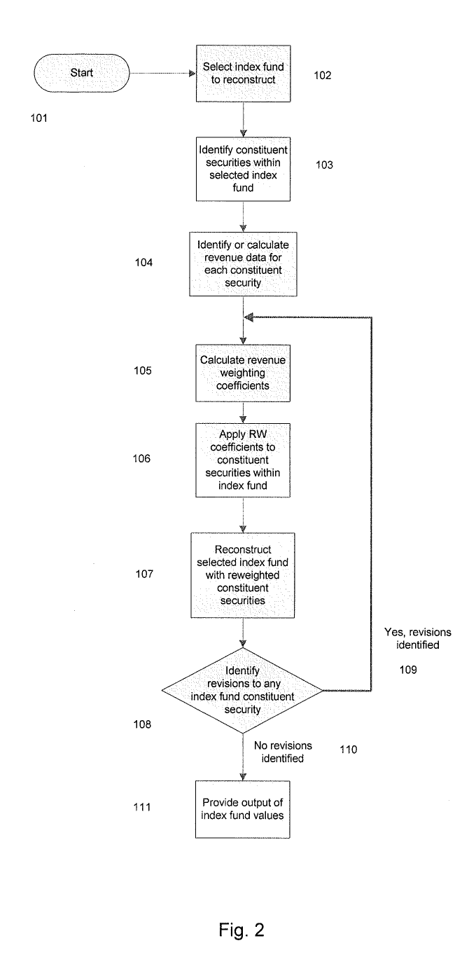

FIG. 2 provides a block diagram of an embodiment of the inventive method illustrating the steps to reconstruct a known index fund based upon annual revenue weighting of each of the constituent securities. After the start 101 of the process, the next step 102 is to identify and select the index fund that is desired to be reconstructed. There are two aspects of the index fund that are required to be known for the method to be applied. First, the index fund and each of the constituent securities held by the index fund must be identifiable and known. Second, certain financial information and data associated with each of the companies represented by the constituent securities must also be known or calculable. More particularly, revenue data for each of the companies represented in the index fund must be known or able to be determined for the method to be able to reconstruct the index fund.

Upon identification and selection of the known index fund to be reconstructed, each of the individual constituent securities and the associated company are then identified 103. The reason that the individual security and associated company is identified is that revenue data for each of the companies is required to be identified or calculated 104 in order to determine a revenue weighting coefficient for each constituent security. More particularly, the revenue data is used to calculate 105 a weighting coefficient for each of the constituent companies.

The calculation 105 of the revenue weighting coefficients is a function of the revenue data for each of the representative companies. In one embodiment, the inventive method considers each of the constituent securities in a known index fund (having n securities within the index fund) and weights or re-proportions each said constituent security based upon a revenue weighted coefficient. The revenue weighted coefficient, RWᵢ, for each constituent security in the index fund, is calculated based upon the annual revenue of the constituent company as a percentage of the total annual revenue of all of the constituent securities within the index fund. In equation format,

RWᵢ=fcn(ARᵢ/ARᵢ+ARᵢ₊₁+ARᵢ₊₂+ARᵢ₊₃+ . . . +ARₙ)

where,

ARᵢ=annual revenue of each constituent company

and

ARₙ=annual revenue of constituent company n,

for an index fund having i, i+1, i+2, i+3 up to n constituent securities within the known index fund.

With the calculated revenue weighted coefficients, RWᵢ, for each constituent security, the coefficient is applied 106 to each respective constituent security. The known index fund is then reconstructed 107 using the same constituent securities, and using the revenue weighting analysis to reproportion the holdings of the constituent securities based upon the revenue weighting coefficients applied to each constituent company within the index fund.

In a preferred embodiment of the revenue weighting method, if the known securities fund changes one or more of the constituent securities, then the method provides a step 108 to identify those changes or revisions to the constituent security, and then recalculate 109, 105 the revenue weighing coefficients with the new constituent securities. This recalculation would be required where a company represented in a known index fund is removed from the index fund and/or is replaced by another company. This often happens in index funds where the value of a company may not be performing as expected, and thus is replaced by another company which has a better value and higher investment performance.

If there are no changes or revisions 110 to the index fund constituent companies, then the index fund constituent proportions and values may be finally calculated 111.

An alternative embodiment of the inventive method allows for consideration of changes in the constituent companies' revenues at intervals less than each year. For example, as shown in FIG. 2 and described in the above embodiment, the calculation of the RWᵢ coefficients, is undertaken each calendar year. Instead, intermediate recalculation of the coefficients, and reconstruction of the index fund could be easily accomplished. Because many companies reconcile financial information on a quarterly basis, recalculation of the revenue coefficients, RWᵢ, could be scheduled at the end of each calendar quarter. In equation format,

RWᵢ=fcn(QRᵢ/QRᵢ+QRᵢ₊₁+QRᵢ₊₂+QRᵢ₊₃+ . . . +QRₙ)

where,

QRᵢ=quarter end revenue of each constituent company i,

and

QRₙ=quarter end revenue of constituent company n,

for an index fund having i, i+1, i+2, i+3 up to n constituent securities within the known index fund.

Alternatively, because a company's revenue may vary substantially each month, recalculation of the revenue coefficients, RWᵢ, could be scheduled at the end of each month. In equation format,

RWᵢ=fcn(MRᵢ/MRᵢ+MRᵢ₊₁+MRᵢ₊₂+MRᵢ₊₃+ . . . +MRₙ)

where,

MRᵢ=month end revenue of each constituent company i,

and

MRₙ=month end revenue of constituent company n,

for an index fund having i, i+1, i+2, i+3 up to n constituent securities within the known index fund.

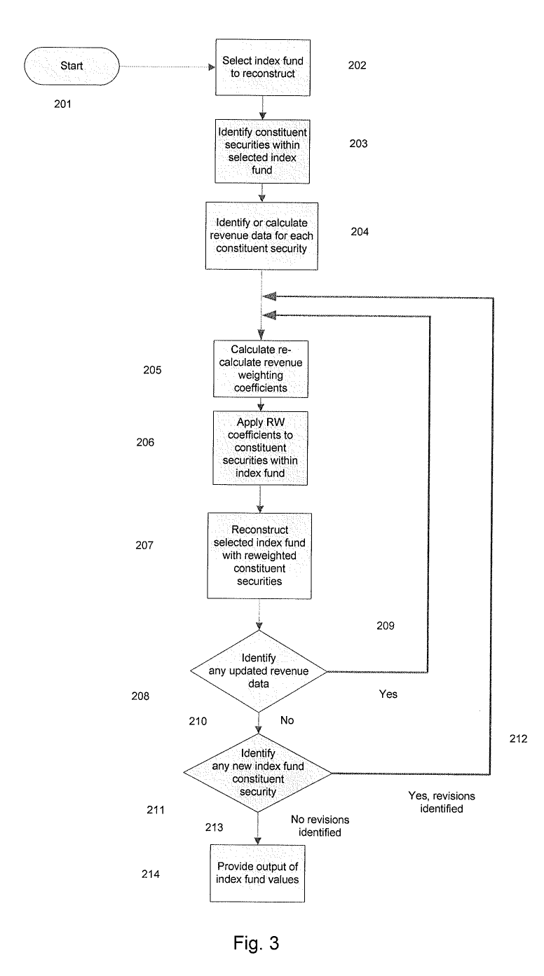

FIG. 3 illustrates the method of recalculation of the weighting coefficients at intermediate intervals. Such intermediate recalculation intervals can be, as noted, quarterly, monthly, daily, or even real-time necessarily using a computer processor as variations or changes occur in revenue data during the trading day. Similar to the flow illustrated in FIG. 2, after step 201 (the process start), step 202 is to identify and select the index fund that is desired to be reconstructed. With the known index fund that is to be reconstructed identified 202, each of the individual constituent securities/companies are next identified 203. The revenue data for each of the identified constituent companies is then identified or calculated 204. Again, it is the revenue data that is necessary to calculate 205 the revenue weighting coefficients for each constituent security.

The calculated 205 revenue weighted coefficients, RWᵢ, for each constituent security, are next applied 206 to each respective constituent security to determine the proportion of each constituent security that should be included in the reconstructed known index fund. The index fund is then reconstructed 207 using the same constituent securities as in the original fund, but using the revenue weighting analysis to reproportion the holdings of the constituent securities based upon the calculated revenue weighting coefficients.

As described, because a company's revenue data will vary and fluctuate during each year, such variations may be helpful to monitor and account for in the reconstructed index fund. Intermediate, or interim monitoring of each constituent company's revenue may be undertaken at quarterly, monthly, or other intervals. Step 208 in FIG. 3 shows the inquiry to determine whether any of the constituent company's revenue data has changed or been updated. If such changes have occurred, and are to be incorporated into the reconstructed index fund, the weighting coefficients are recalculated 209, 205 based upon the updated revenue data.

If instead, there are no revenue data changes, or there are revenue data changes that need not be incorporated into the reconstructed index fund 210, then the process next identifies whether there are new or replaced index fund constituent securities 211. If there are changes to the constituent securities, or represented companies within the index fund 212, then the revenue weighting coefficients are to be recalculated 205 to account for and incorporate the new or replaced constituent securities. Similar to the process described above and illustrated in FIG. 2, where there are no changes 213 to the index fund constituent companies, then the index fund constituent proportions and values may be finally calculated 214.

While examples of known index funds are the S&P 500 and the Russell 1000, the inventive methodology can also be applied to other index funds, including for example, the S&P Mid-Cap index or the S&P Small-Cap index. Indeed, the inventive method and process can be applied to reconstruct and re-designate the proportionate holdings in any known index where the annual revenue of each constituent company, and the total annual revenue of the constituent companies is known and available.

The above detailed description teaches certain preferred embodiments of the present inventive method and system for weighting and recalculating the proportion of individual securities maintained within a known index investment fund. While preferred embodiments have been described and disclosed, it will be recognized by those skilled in the art that modifications and/or substitutions are possible and such modifications and substitutions are within the true scope and spirit of the present invention. It is likewise understood that the attached claims are intended to cover all such modifications and/or substitutions.

What is claimed is:

1. A computerized system for re-constructing a selected, known, publicly available, index fund, said index fund having a plurality of known constituent securities associated with particular business entities, the computerized system comprising:
a computer processor executing the following steps:
(a) calculating a weighting coefficient for each of the plurality of known constituent securities, where each of the weighting coefficients is determined as the ratio of the revenue of the underlying company for each of the constituent securities to the total revenue for all of the index fund companies;
(b) applying each calculated weighting coefficient to each of the respective plurality of constituent securities to calculate the proportion of each of the respective plurality of constituent securities to be held in the reconstructed fund; and
(c) reconstructing the known index fund based upon the proportion of each of the plurality of constituent securities determined by applying the calculated weighting coefficients.

2. The computerized system for re-constructing a known index fund, as provided in claim 1, wherein the computer processor further executes the following steps:
(d) recalculating on a real-time and set periodic basis, the weighting coefficients of step (a) for each of the plurality of constituent securities within the known index fund; and
(e) reconstructing the known index fund based upon the proportion of each of the plurality of constituent securities determined by applying the recalculated weighting coefficients.

3. The computerized system for re-constructing a known index fund, as provided in claim 2, wherein the periodic basis is each calendar year end.

4. The computerized system for re-constructing a known index fund, as provided in claim 2, wherein the periodic basis is each month end.

5. The computerized system for re-constructing a known index fund, as provided in claim 2, wherein the periodic basis is the end of each trading day.

6. The computerized system for re-constructing a known index fund, as provided in claim 1, wherein the computer processor further executes the step of (d) recalculating in real-time the weighting coefficients of step (a) for each of the plurality of constituent securities within the known index fund.

7. The computerized system for re-constructing a known index fund, as provided in claim 1, wherein the computer processor further executes the step of (d) recalculating in real-time the weighting coefficients of step (a) for each of the plurality of constituent securities within the known index fund when revenue data for any of the index fund companies is updated and available.

8. A computerized method for re-constructing a known, publicly available, index fund, said index fund have a plurality of constituent securities, the computerized method using an electronic processor, and comprising the steps, as executed by the electronic processor, of:
(a) selecting a known index fund, said index fund having a plurality of constituent securities associated with a plurality of companies;
(b) calculating in real-time a weighting coefficient for each of the plurality of constituent securities within the known index fund, wherein each weighting coefficient is based upon revenue of the underlying company for each of the constituent securities as a percentage of the total revenue for all of the index fund companies;
(c) applying each calculated weighting coefficient to each of the respective plurality of constituent securities to calculate the proportion of each of the respective plurality of constituent securities to be held in the reconstructed fund;
(d) reconstructing the known index fund using each of the plurality of constituent securities as proportioned according to the applied weighting coefficients; and
(e) recalculating in real-time the weighting coefficients for each of the plurality of constituent securities within the known index fund on a set periodic basis;
(f) applying each recalculated weighting coefficient to each of the respective plurality of constituent securities to recalculate the proportion of each of the respective plurality of constituent securities to be held in the reconstructed fund; and
(g) reconstructing the known index fund based upon the proportion of each of the plurality of constituent securities determined by applying the recalculated weighting coefficients.

9. A computerized system for re-constituting the number of shares held for each of a plurality of constituent securities within a selected, known, publicly available, index fund, said index fund having at least two constituent securities associated with known business entities, the computerized system comprising:
a computer processor executing the following steps:
(a) calculating in real-time a weighting coefficient for each of the constituent securities within the known index fund, wherein the weighting coefficient is based upon the revenue of the underlying company for each of the constituent securities as a percentage of the total revenue for the index fund companies;
(b) applying each calculated weighting coefficient to each of the respective at least two constituent securities; and
(c) reconstructing the known index fund using each of the at least two constituent securities as proportioned according to the applied weighting coefficients.

10. The computerized system for re-constructing a known index fund, as provided in claim 9, wherein the computer processor further executes the following steps:
(d) recalculating in real-time and on a set periodic basis, the weighting coefficients of step (a) for each of the at least two constituent securities within the known index fund; and
(e) reconstructing the known index fund based upon the proportion of each of the at least two constituent securities determined by applying the recalculated weighting coefficients.

11. The computerized system for re-constructing a known index fund, as provided in claim 10, wherein the periodic basis is each calendar year end.

12. The computerized system for re-constructing a known index fund, as provided in claim 10, wherein the periodic basis is each month end.

13. The computerized system for re-constructing a known index fund, as provided in claim 10, wherein the periodic basis is the end of each trading day.

14. The computerized system for re-constructing a known index fund, as provided in claim 10, further comprising the step of (d) recalculating in real-time the weighting coefficients of step (a) for each of the plurality of constituent securities within the known index fund when revenue data for any of the index fund companies is updated and available.

15. The computerized system for re-constructing a known index fund, as provided in claim 2, wherein the periodic basis for recalculation of the weighting coefficients is real-time.

16. The computerized system for re-constructing a known index fund, as provided in claim 10, wherein the periodic basis for recalculation of the weighting coefficients is real-time.

17. The computerized system for re-constructing a known index fund, as provided in claim 1, wherein the computer processor further executes the step of (d) recalculating on a real-time basis the weighting coefficients of step (a) for each of the plurality of constituent securities within the known index fund.

18. The computerized system for re-constructing a known index fund, as provided in claim 2, wherein the known index is a publicly and publicly available traded index.
